(19) United States
(12) Patent Application Publication
(10) Pub. No.: US 2015/0274990 A1
(43) Pub. Date: Oct. 1, 2015

(54) Abrasion Resistant Superhydrophobic Coatings

(71) Applicant: Mark D. Shaw, Ponte Vedra, FL (US)

(72) Inventor: Mark D. Shaw, Ponte Vedra, FL (US)

(21) Appl. No.: 14/673,067

(22) Filed: Mar. 30, 2015

Related U.S. Application Data
(60) Provisional application No. 61/971,772, filed on Mar. 28, 2014.

(51) Int. Cl. C09D 7/12; C08K 3/36; C08K 11/00; C08K 3/22

(52) U.S. Cl. CPC C09D 7/1216; C08K 3/22; C08K 3/36; C08K 11/00; C08K 2003/2241; C08K 2003/2227

(57) ABSTRACT

Improved superhydrophobic and/or super-oleophobic multi-layer coating compositions or treatments having increased durability and abrasion resistance, the compositions having a bottom layer with solid particles possessing high abrasion resistance and a top layer with particles imparting the superhydrophobic and/or super-oleophobic properties, wherein the bottom layer particles are significantly larger and significantly more abrasion-resistant than the top layer particles, such that portions of the bottom layer particles are exposed on the surface when part of the top layer is abraded, thereby creating an effective contact surface that significantly reduces further abrasion of the top layer without significantly reducing the superhydrophobic and/or super-oleophobic properties.

This application claims the benefit of U.S. Provisional Patent Application Ser. No. 61/971,772, filed Mar. 28, 2014.

### BACKGROUND OF THE INVENTION

The invention relates generally to hydrophobic and oleophobic coating compositions useful in making treated objects waterproof, stain resistant and oil repellant, and more particularly relates to such coatings utilizing nanotechnology to produce superhydrophobic and super-oleophobic coatings.

When liquid contacts a substrate surface a bead of liquid is formed having a contact angle that can be measured. For water for example, a contact angle less than approximately 90 degrees defines a hydrophilic surface while a contact angle greater than approximately 90 degrees defines a hydrophobic surface. A contact angle greater than approximately 145 degrees is considered to define a superhydrophobic surface. Representative superhydrophobic or super-oleophobic compositions and treatments suitable for this invention may include but not be limited to the compositions and treatments disclosed in U.S Patent Publication Nos. 2013/0109261, 2012/0009396, 2010/0314575, 2012/0045954, and 2006/0029808, and also in

U.S. Pat. Nos. 8,007,638, 6,103,379, 6,645,569, 6,743,467, 7,985,451, 8,187,707, 8,202,614, 7,998,554, 7,989,619, 5,042,991, 8,361,176, 8,258,206 and 6,723,378, and also in International Publication No. WO2013/058843. A rough surface on a micro scale increases the hydrophobic characteristics of the surface as air bubbles will be trapped between the liquid and the surface.

Currently utilized superhydrophobic and/or super-oleophobic coatings or treatments suffer in many cases from low abrasion resistance, which can severely limit the effective useful life of the coatings when applied to objects that are likely to be subjected to weather or other contact abrasion. Superhydrophobic and oleophobic coatings are delicate by nature as the surface morphology is a key component in the ability of a coating to be superhydrophobic and/or oleophobic. The high points of the surface coating are usually made from thin and short silica (or zinc titanium, etc.) members that are easily worn down through handling and rubbing. Superhydrophobic and/or super-oleophobic coatings may comprise a single-layer coating or a multi-layer coating with a top and bottom coat. Traditionally, the use of a bottom coat is to bond the coating to the substrate by providing suitable bonding surfaces for the top coat and the substrate. In these cases, the bottom coat does not contribute to the superhydrophobic and/or super-oleophobic properties—these effects are created by the top coat. The bottom coat serves as a primer and/or adhesive type material to provide a bond to the substrate.

It is an object of this invention to provide a coating or treating composition that increases abrasion resistance in superhydrophobic and/or super-oleophobic coatings or treatments, thereby significantly increasing the effective life of the coating or treatment.

### SUMMARY OF THE INVENTION

The invention in various embodiments is an abrasion resistant superhydrophobic and/or super-oleophobic coating or treatment applicable to a substrate surface, the coating or treatment producing a surface having a liquid contact angle of greater than approximately 145 degrees.

The invention further embodies a method of imparting superhydrophobic and/or super-oleophobic properties to a substrate. The coating or treatment is a multi-layer composite comprising an inner or bottom layer comprising a binder material embedded with abrasion-resistant particles and an outer or top layer comprising a binder material and nano-sized particles. The abrasion-resistant particles in the bottom layer are at least ten times greater in size than the particles of the top layer, and preferably are at least one hundred times greater. The top layer may be composed of known superhydrophobic and super-oleophobic compositions. The bottom layer acts as a transition layer between the substrate surface and the top layer, and is not required to possess superhydrophobic or super-oleophobic characteristics. Over time the top layer, being a layer possessing lesser abrasion-resistance than the bottom layer, will abrade such that the small upper portions of some of the abrasion-resistant particles in the bottom layer become exposed on the surface of the top layer. The exposed particles, being dispersed across the surface, produce an effective contact surface having good abrasion resistance characteristics, such that abrasion of the top layer is significantly reduced, thereby greatly extending the effective life of the superhydrophobic or super-oleophobic top layer. Because only very small areas of the abrasion-resistant particles are exposed on the surface of the top layer, the superhydrophobic and super-oleophobic characteristics of the top layer are not significantly reduced.

Furthermore, with large scale size difference between the top layer particles and the bottom layer particles, it is possible for portions of the top layer with the superhydrophobic and super-oleophobic nano-sized particles to reside in pockets or valleys present in the exposed portions of the macro-sized abrasion-resistant particles of the bottom layer, thereby resulting in even less reduction in the superhydrophobic and super-oleophobic properties.

In alternative form, the invention in various embodiments is a composition possessing superhydrophobic and/or super-oleophobic properties when applied to a substrate, said composition comprising a bottom layer comprising a binder material and a plurality of abrasion-resistant particles; a top layer comprising a binder material and a plurality of nano-sized particles imparting superhydrophobic or super-oleophobic properties to said top layer; wherein said bottom layer particles are significantly larger and possess significantly greater abrasion resistance than said top layer particles, such that upon removal by abrasion of a portion of said top layer, portions of said bottom layer particles are exposed through said top layer, said exposed portions of said bottom layer particles defining an effective contact surface to reduce further abrasion of said top layer. Furthermore, embodiments may present such a composition wherein said bottom layer particles are at least ten times larger than said top layer particles; wherein said bottom layer particles are at least one hundred times larger than said top layer particles; wherein said top layer particles are composed of fumed silica; wherein said bottom layer particles are chosen from the group of particles consisting of titanium oxide, alumina, volcanic rock, and diatomaceous earth; and/or wherein portions of said top layer remain embedded in pockets of said exposed portions of said bottom layer particles.

Furthermore, the invention may embody a method of providing a superhydrophobic and/or super-oleophobic surface on a substrate comprising the steps of applying to said substrate a bottom layer comprising a binder material and a plurality of abrasion-resistant particles;

applying to said bottom layer a top layer comprising a binder material and a plurality of nano-sized particles imparting superhydrophobic or super-oleophobic properties to said top layer; wherein said bottom layer particles are significantly larger and possess significantly greater abrasion resistance than said top layer particles, such that upon removal by abrasion of a portion of said top layer, portions of said bottom layer particles are exposed through said top layer, said exposed portions of said bottom layer particles defining an effective contact surface to reduce further abrasion of said top layer. Additionally, the method may be one further comprising the steps of selecting said bottom layer particles that are at least ten times larger than said top layer particles; further comprising the steps of selecting said bottom layer particles that are at least one hundred times larger than said top layer particles; further comprising the step of selecting fumed silica as said top layer particles and/or further comprising the step of selecting particles chosen from the group of particles consisting of titanium oxide, alumina, volcanic rock, and diatomaceous earth as said bottom layer particles.

### BRIEF DESCRIPTION OF THE DRAWINGS

FIG. 1 is a schematic representation, not to scale, illustrating the multi-layer coating or treatment as applied to a substrate.

FIG. 2 is a schematic representation, not to scale, of a portion of the coating or treatment of FIG. 1 after significant abrasion of the superhydrophobic and/or super-oleophobic top layer has resulted in portions of the abrasion-resistant bottom layer particles becoming exposed on the top layer surface and defining an effective contact surface to preclude or minimize further abrasion of the top layer.

FIG. 3 is a top view of an abraded top layer showing the exposed portions of the bottom layer particles.

### DETAILED DESCRIPTION OF THE INVENTION

For purposes of enablement of this disclosure, representative superhydrophobic or super-oleophobic compositions, coatings and treatments suitable for this invention may include, but are not limited to, the compositions and treatments disclosed for example in U.S Patent Publication Nos. 2013/0109261, 2012/0009396, 2010/0314575, 2012/0045954, and 2006/0029808, and also in U.S. Pat. Nos. 8,007,638, 6,103,379, 6,645,569, 6,743,467, 7,985,451, 8,187,707, 8,202,614, 7,998,554, 7,989,619, 5,042,991, 8,361,176, 8,258,206 and 6,723,378, and also in International Publication No. WO2013/058843. The terms superhydrophobic and super-oleophobic define a surface having a liquid contact angle of greater than approximately 145 degrees.

The figures herein are schematic representations of a multi-layer coating or treatment applied to a substrate in order to impart superhydrophobic and/or super-oleophobic properties. The invention in various embodiments is an abrasion resistant superhydrophobic and/or super-oleophobic coating or treatment applicable to a substrate surface 10, the coating or treatment producing an exposed surface having a liquid contact angle of greater than approximately 145 degrees. The invention further embodies a method of imparting superhydrophobic and/or super-oleophobic properties to a substrate 10. The coating or treatment is a multi-layer composite comprising an inner or bottom layer 20 comprising a binder material 23 embedded with abrasion-resistant particles 21 and an outer or top layer 30 comprising a binder material 32 and nano-sized particles 31. The abrasion-resistant particles 21 in the bottom layer 20 are significantly harder, more durable and possess higher abrasion-resistance than the top layer particles 31. The abrasion-resistant particles 21 in the bottom layer 20 are at least ten times greater in size than the particles 31 of the top layer, and preferably are at least one hundred times greater. The top layer 30 may be composed of known superhydrophobic and super-oleophobic compositions, many of which comprise particles 31 of fumed silica, which is light, small and capable of being held in place as it self-assembles with other silica in the binder material 32.

The bottom layer 20 acts as a transition layer between the substrate surface 10 and the top layer 30, and is not required to possess superhydrophobic or super-oleophobic characteristics. The bottom layer binder material 23 is chosen from suitable binders able to bond with the substrate 10 and the top layer 30. The bottom layer embedded particles are durable, hard and abrasion resistant, such as for example particles of titanium oxides, alumina, volcanic rock, or diatomaceous earth. The abrasion-resistant particles 21 preferably have a rough, jagged surface morphology to provide mechanical interlocking locations for the binder material 23 of the bottom layer to better adhere and encapsulate the solid particles 21 within the bottom layer 20. The bottom layer particles 21 must be capable of remaining dispersed prior to and during application and not clump into larger sizes where it cannot be consistently applied.

As shown in FIG. 1, the bottom layer 20 is applied to the substrate 10 in suitable manner, such as by spraying, brushing, dipping or the like. The top layer 30 is applied in like appropriate manner to the bottom layer 20, such that the top layer 30 defines the exposed surface of the multi-layer coating. Depending on the thickness of the top layer 30 and the size of the bottom layer abrasion-resistant particles 22, the exposed top layer surface may be relatively smooth as shown in the representation, or may be rougher when the bottom coat particles 22 are sufficiently large to affect the surface morphology of the top layer 30.

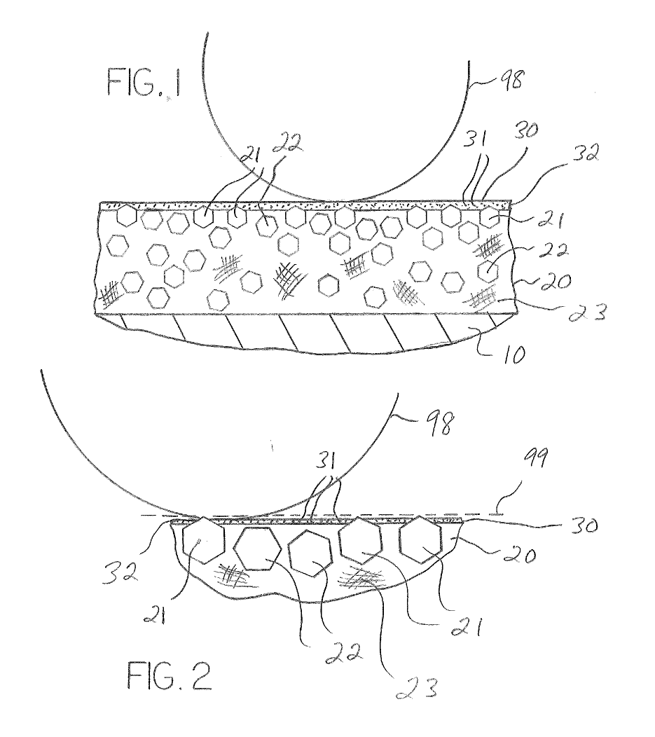

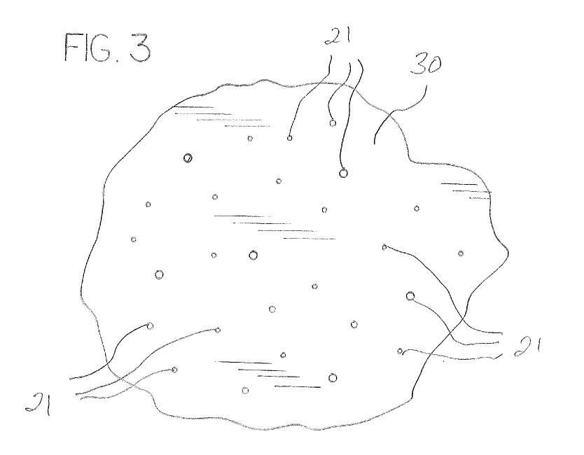

As shown in FIG. 2, over time the top layer 30, being a layer possessing lesser abrasion-resistance than the bottom layer 20, will abrade such that the small upper portions 22 of the uppermost abrasion-resistant particles 21 in the bottom layer become exposed and extend to or slightly above the surface of the top layer 30. The plurality of exposed portions 22 having good abrasion resistance characteristics, being dispersed across the exposed surface as shown in FIG. 3, produces an effective contact surface 99 a short distance above the surface of the top layer 30, such that abrasion of the top layer 30 is significantly reduced when abrasive materials are contacted, thereby greatly extending the effective life of the superhydrophobic or super-oleophobic top layer 30. Because only very small portions 22 of the abrasion-resistant particles 21 are exposed on the surface of the top layer 30, the superhydrophobic and super-oleophobic characteristics of the top layer 30 are not significantly reduced, in that the contact angles of liquid droplets 98 are not significantly reduced.

Furthermore, with large scale size difference between the top layer particles 31 and the bottom layer particles 21, it is possible for portions of the top layer 30 with the superhydrophobic and super-oleophobic nano-sized particles 31 to reside in pockets or valleys present in the exposed portions 22 of the macro-sized abrasion-resistant particles 21 of the bottom layer 20, thereby resulting in even less reduction in the superhydrophobic and super-oleophobic properties of the top layer 30. The exposed portions 22, in combination with the adjacent top layer 30, also allow air to be trapped between beneath the liquid droplet 99 to maintain the superhydrophobic and super-oleophobic characteristics, and provide a layer of air to be a cushion for the liquid to roll across.

It is contemplated that equivalents and substitutions for certain elements and steps described above may be obvious to those of skill in the art, and therefore the true scope and definition of the invention is to be as set forth in the following claims.

I claim:

1. A composition possessing superhydrophobic and/or super-oleophobic properties when applied to a substrate, said composition comprising:
a bottom layer comprising a binder material and a plurality of abrasion-resistant particles;
a top layer comprising a binder material and a plurality of nano-sized particles imparting superhydrophobic or super-oleophobic properties to said top layer;
wherein said bottom layer particles are significantly larger and possess significantly greater abrasion resistance than said top layer particles, such that upon removal by abrasion of a portion of said top layer, portions of said bottom layer particles are exposed through said top layer, said exposed portions of said bottom layer particles defining an effective contact surface to reduce further abrasion of said top layer.

2. The composition of claim 1, wherein said bottom layer particles are at least ten times larger than said top layer particles.

3. The composition of claim 2, wherein said bottom layer particles are at least one hundred times larger than said top layer particles.

4. The composition of claim 1, wherein said top layer particles are composed of fumed silica.

5. The composition of claim 1, wherein said bottom layer particles are chosen from the group of particles consisting of titanium oxide, alumina, volcanic rock, and diatomaceous earth.

6. The composition of claim 4, wherein said bottom layer particles are chosen from the group of particles consisting of titanium oxide, alumina, volcanic rock, and diatomaceous earth.

7. The composition of claim 2, wherein said top layer particles are composed of fumed silica and said bottom layer particles are chosen from the group of particles consisting of titanium oxide, alumina, volcanic rock, and diatomaceous earth.

8. The composition of claim 3, wherein said top layer particles are composed of fumed silica and said bottom layer particles are chosen from the group of particles consisting of titanium oxide, alumina, volcanic rock, and diatomaceous earth.

9. The composition of claim 10, wherein portions of said top layer remain embedded in pockets of said exposed portions of said bottom layer particles.

10. A method of providing a superhydrophobic and/or super-oleophobic surface on a substrate comprising the steps of:
applying to said substrate a bottom layer comprising a binder material and a plurality of abrasion-resistant particles;
applying to said bottom layer a top layer comprising a binder material and a plurality of nano-sized particles imparting superhydrophobic or super-oleophobic properties to said top layer;
wherein said bottom layer particles are significantly larger and possess significantly greater abrasion resistance than said top layer particles, such that upon removal by abrasion of a portion of said top layer, portions of said bottom layer particles are exposed through said top layer, said exposed portions of said bottom layer particles defining an effective contact surface to reduce further abrasion of said top layer.

11. The method of claim 10, further comprising the steps of selecting said bottom layer particles that are at least ten times larger than said top layer particles.

12. The method of claim 11, further comprising the steps of selecting said bottom layer particles that are at least one hundred times larger than said top layer particles.

13. The method of claim 10, further comprising the step of selecting fumed silica as said top layer particles.

14. The method of claim 10, further comprising the step of selecting particles chosen from the group of particles consisting of titanium oxide, alumina, volcanic rock, and diatomaceous earth as said bottom layer particles.

15. The method of claim 13, further comprising the step of selecting particles chosen from the group of particles consisting of titanium oxide, alumina, volcanic rock, and diatomaceous earth as said bottom layer particles.

16. The method of claim 11, further comprising the step of selecting fumed silica as said top layer particles and selecting particles chosen from the group of particles consisting of titanium oxide, alumina, volcanic rock, and diatomaceous earth as said bottom layer particles.

17. The method of claim 12, further comprising the step of selecting fumed silica as said top layer particles and selecting particles chosen from the group of particles consisting of titanium oxide, alumina, volcanic rock, and diatomaceous earth as said bottom layer particles.
